(19) United States
(12) Patent Application Publication
(10) Pub. No.: US 2020/0284771 A1
(43) Pub. Date: Sep. 10, 2020

(54) METHODS, COMPOSITIONS AND KITS USEFUL FOR ION EXCHANGE CHROMATOGRAPHY AND MASS SPECTROMETRY ANALYSIS

(71) Applicant: Waters Technologies Corporation, Milford, MA (US)

(72) Inventors: Qi Wang, Belmont, MA (US); Matthew A. Lauber, North Smithfield, RI (US); Samantha Ippoliti, Franklin, MA (US); Ying Qing Yu, Uxbridge, MA (US)

(21) Appl. No.: 16/811,188

(22) Filed: Mar. 6, 2020

Related U.S. Application Data
(60) Provisional application No. 62/815,514, filed on Mar. 8, 2019.

(51) Int. Cl. G01N 30/96; H01J 49/26

(52) U.S. Cl. CPC G01N 30/96; H01J 49/26

(57) ABSTRACT

The present disclosure relates to methods, compositions and kits useful for the enhanced pH gradient cation exchange chromatography of a variety of analytes. In various aspects, the present disclosure pertains to chromatographic elution kits comprising (a) a first aqueous buffer solution having a first pH and comprising a first organic acid salt in a first concentration and (b) a second aqueous buffer solution having a second pH and comprising the first organic acid salt in a second concentration, wherein the first organic acid salt comprises a first organic acid ammonium salt, wherein the second pH is greater than the first pH, and wherein the second concentration is greater than the first concentration. In various aspects, the present disclosure pertains to methods of using such aqueous buffer solutions in chromatographic separations.

### CROSS-REFERENCE TO RELATED APPLICATIONS

This application claims the benefit of and priority to U.S. Provisional Patent Application No. 62/815,514, filed on Mar. 8, 2019, the entire contents of which are incorporated by reference.

### FIELD

The present disclosure relates to methods, compositions and kits useful for the enhanced gradient ion exchange chromatography of a variety of analytes.

### BACKGROUND

Ion exchange chromatography (IEX) has been widely applied for the separation and analysis of proteins. In IEX, proteins are separated based on their ionic interactions with oppositely charged moieties present on a stationary phase. Under a condition where pH is lower than the isoelectric point (pI), a protein is positively charged. As mobile phase pH increases, the protein gradually loses positive charges and becomes neutral, then negatively charged. In cation exchange chromatography, positively charged proteins adsorb to a negatively charged stationary phase. These proteins can be made to elute via salt or pH gradient mechanisms. In a salt gradient separation, proteins with more charges require higher concentrations of salt, while in a pH gradient technique, proteins with different pIs can be separated through a change in mobile phase pH.

In practice, IEX is of utility in the analysis of many different types of biomolecules and many different types of proteins. A significant amount of information can be gleaned from these separations, particularly when they are applied to the analysis of protein therapeutics. Monoclonal antibodies (mAbs), as a type of protein therapeutics, have been used for the treatment of many diseases. As an intrinsic outcome from production, post-translational modifications (PTMs) of protein therapeutics need to be carefully characterized since minor structural differences can have significant impacts on drug stability, potency, and efficacy. Some of the modifications, such as deamidation, sialylation, C-terminal lysine variation, etc., cause a change to protein net charge. IEX is a valuable means to detecting and monitoring the formation of these unique protein variants.

However, because of the ubiquitous use of nonvolatile buffers at high ionic strengths in both salt and pH gradient methods, most examples of detailed analyses have relied on time-consuming offline fraction collection or cumbersome multidimensional LC-mass spectrometry (MS). More ideally, it is desired to achieve optimized, robust IEX separations that are based on volatile mobile phase compositions that facilitate direct coupling with mass spectrometry. To date, two exemplary IEX-MS analyses have been published. Leblanc and co-workers developed a dual salt/pH gradient method for charge variant characterization of mAbs with a middle-up approach. Leblanc, Y.; Ramon, C.; Bihoreau, N.; Chevreux, G., “Charge variants characterization of a monoclonal antibody by ion exchange chromatography coupled on-line to native mass spectrometry: Case study after a long-term storage at +5 degrees C.” Journal of chromatography. B, Analytical technologies in the biomedical and life sciences 2017, 1048, 130-139. In this work, IdeS digested subunits of mAbs were directly analyzed with IEX-MS under native conditions using volatile salts ammonium formate and ammonium acetate over the pH range of 3.9 to 7.4. In practice, the chromatographic resolution and quality of MS obtained with this technique has proven to be non-ideal and the mobile phase composition is needlessly complicated from having more constituents than needed—as it continues both ammonium formate and ammonium acetate. Ultimately, the interpretability of mass spectra from this method is compromised by an abundance of salt adducts and that it depends on high salt concentrations. More recently, Fuss' and co-workers developed a pH gradient method based on ammonium bicarbonate, acetic acid, and ammonium hydroxide. Fussl, F.; Cook, K.; Scheffler, K.; Farrell, A.; Mittermayr, S.; Bones, J., “Charge Variant Analysis of Monoclonal Antibodies Using Direct Coupled pH Gradient Cation Exchange Chromatography to High-Resolution Native Mass Spectrometry.” Analytical chemistry 2018, 90 (7), 4669-4676. This mobile phase system provides a relatively constant conductivity over the pH range of 5.3 to 10.18 for the analysis of intact mAbs with different pIs. However, fine tuning of the gradient is required for each analyte, and carbon dioxide adducts are readily observed in the resulting MS spectra as a consequence of the mobile phase containing ammonium bicarbonate.

### SUMMARY

The present disclosure provides novel methods, mobile phase compositions, and kits to facilitate gradient ion exchange chromatography of analytes. The methods, mobile phase compositions, and kits of the present disclosure are advantageous in that they are compatible with MS detection of the analytes.

In various aspects, the present disclosure pertains to chromatographic elution kits that comprise (a) a first aqueous buffer solution having a first pH and comprising a first organic acid salt in a first concentration and (b) a second aqueous buffer solution having a second pH and comprising the first organic acid salt in a second concentration, wherein the first organic acid salt comprises a first organic acid ammonium salt, wherein the second pH is greater than the first pH, and wherein the second concentration is greater than the first concentration.

In some embodiments which can be used in conjunction with any of the above aspects, each of the first and second aqueous buffer solutions contains less than 20%, less than 10%, than 5%, or less than 1% of a second organic acid ammonium salt that differs from the first organic acid ammonium salt.

In some embodiments which can be used in conjunction with any of the above aspects, the first organic acid salt consists essentially of the first organic acid ammonium salt.

In some embodiments which can be used in conjunction with any of the above aspects, the first organic acid ammonium salt is the sole organic acid ammonium salt in each of the first and second aqueous buffer solutions.

In some embodiments which can be used in conjunction with any of the above aspects and embodiments, each of the first and second aqueous buffer solutions do not contain ammonium bicarbonate.

In some embodiments which can be used in conjunction with any of the above aspects and embodiments, the first and second aqueous buffer solutions each has a concentration of sodium and potassium that is less than 100 ppb, beneficially, less than 20 ppb.

In some embodiments which can be used in conjunction with any of the above aspects and embodiments, the first aqueous buffer solution has pH between 4 and 6, more beneficially between 4.5 and 5.5, and a concentration between 20 and 120 mM, more beneficially between 40 and 100 mM.

In some embodiments which can be used in conjunction with any of the above aspects and embodiments, the second aqueous buffer solution has a pH between 7.5 and 9.0, more beneficially 8 and 8.5, and a concentration between 100 and 300 mM, more beneficially between 120 and 200 mM.

In some embodiments which can be used in conjunction with any of the above aspects and embodiments, the first aqueous buffer solution has a conductivity ranging from 0.1 millisiemins (mS) to 10 mS and the second aqueous buffer solution has a conductivity ranging from 3 mS to 100 mS.

In some embodiments which can be used in conjunction with any of the above aspects and embodiments, a plot of pH versus volume percent of the first aqueous buffer solution relative to a total volume for a binary mixture of the first aqueous buffer solution and the second aqueous buffer solution is linear.

As used herein, a plot of one variable versus another variable is “linear” when a linear least squares regression analysis yields a coefficient of determination (R2) value of at least 0.90, more typically at least 0.95.

In some embodiments which can be used in conjunction with any of the above aspects and embodiments, a plot of conductivity versus volume percent of the first aqueous buffer solution relative to a total volume for a binary mixture of the first aqueous buffer solution and the second aqueous buffer solution is linear.

In some embodiments which can be used in conjunction with any of the above aspects and embodiments, a plot of conductivity versus volume percent of the first aqueous buffer solution relative to a total volume for a binary mixture of the first aqueous buffer solution and the second aqueous buffer solution does not exhibit a negative slope.

In some embodiments which can be used in conjunction with any of the above aspects and embodiments, the chromatographic elution kits further comprise instructions for diluting each of the first and second aqueous buffer solutions that when followed result in a diluted first aqueous buffer solution having a pH between 4 and 6, more beneficially between 4.5 and 5.5, and a concentration of the first organic acid ammonium salt that is between 20 and 120 mM, more beneficially between 40 and 100 mM, and a diluted second aqueous buffer solution having a pH between 7.5 and 9.0, more beneficially 8 and 8.5, and a concentration of the first organic acid ammonium salt that is between 100 and 300 mM, more beneficially between 120 and 200 mM.

In some embodiments which can be used in conjunction with any of the above aspects and embodiments, the diluted first aqueous buffer solution has a conductivity ranging from 0.1 mS to 10 mS and the diluted second aqueous buffer solution has a conductivity ranging from 3 mS to 100 mS.

In some embodiments which can be used in conjunction with any of the above aspects and embodiments, a plot of pH versus volume percent of the diluted first aqueous buffer solution relative to a total volume for a binary mixture of the diluted first aqueous buffer solution and the diluted second aqueous buffer solution is linear.

In some embodiments which can be used in conjunction with any of the above aspects and embodiments, a plot of conductivity versus volume percent of the diluted first aqueous buffer solution relative to a total volume for a binary mixture of the diluted first aqueous buffer solution and the diluted second aqueous buffer solution is linear.

In some embodiments which can be used in conjunction with any of the above aspects and embodiments, a plot of conductivity versus volume percent of the diluted first aqueous buffer solution relative to a total volume for a binary mixture of the diluted first aqueous buffer solution and the diluted second aqueous buffer solution does not exhibit a negative slope.

In some embodiments which can be used in conjunction with any of the above aspects and embodiments, the first organic acid ammonium salt is formed from (a) an organic acid anion selected from formate, acetate, difluoroacetate, trifluoroacetate, propionate, butyrate, carbonate, bicarbonate, oxalate, malonate, succinate, maleate, glutarate, glycolate, lactate, malate, citrate or gluconate and (b) an ammonium cation selected from ammonium, monoalkyl ammonium, dialkyl ammonium, trialkyl ammonium, or tetraalkyl ammonium.

In some embodiments which can be used in conjunction with any of the above aspects and embodiments, the first organic acid ammonium salt is selected from ammonium formate, ammonium acetate, tetramethylammonium formate, tetramethylammonium acetate, triethylammonium acetate, or triethylammonium formate.

In some embodiments which can be used in conjunction with any of the above aspects and embodiments, each of the first and second aqueous buffer solutions are contained in glass-free vessels, for example, polymeric vessels such as those formed from polyolefins such as polyethylene (e.g. HDPE) or fluoropolymers such as polytetrafluoroethylene (PTFE).

In some embodiments which can be used in conjunction with any of the above aspects and embodiments, each of the first and second aqueous buffer solutions further comprises a miscible organic co-solvent at a concentration ranging from 1 to 50%. For example, the miscible organic co-solvent is selected from acetonitrile, methanol, ethanol, n-propanol, or isopropanol among other possibilities.

In some embodiments which can be used in conjunction with any of the above aspects and embodiments, in order to lengthen shelf life, the first and second aqueous buffer solutions may be formulated with a trace amount of bactericidal agent, including by not limited to approximately 100 to 400 ppm of chloroform.

In some embodiments which can be used in conjunction with any of the above aspects and embodiments, in order to lengthen shelf life, the first and second aqueous buffer solutions may be packaged with an oxygen absorbing material.

In some embodiments which can be used in conjunction with any of the above aspects and embodiments, the chromatographic elution kits further comprise an ion exchange chromatographic material.

In some embodiments which can be used in conjunction with any of the above aspects and embodiments, the chromatographic elution kits further comprise an ion exchange chromatographic material and a separation device (e.g., a column, sample preparation device, centrifugation/spin column or microelution plate) that comprises a housing having an inlet and an outlet that is configured to accept and hold the ion-exchange chromatography material.

In some embodiments which can be used in conjunction with any of the above aspects and embodiments, the chromatographic elution kits further comprise a cation exchange chromatography material. The cation exchange chromatography material may comprise, for example, carboxylate groups, sulfonate groups, or both.

In other aspects, the present disclosure pertains to methods for analyzing a sample comprising a plurality of analytes, the method comprising: loading the sample onto an ion-exchange chromatography material in accordance with any of with the above aspects and embodiments thereby binding the plurality of analytes to the ion-exchange chromatography material; and eluting the plurality of analytes from the ion-exchange chromatography material with a mobile phase comprising varying amounts of (a) a first aqueous buffer solution in accordance with any of with the above aspects and embodiments and (b) a second aqueous buffer solution in accordance with any of with the above aspects and embodiments, thereby separating at least some of the plurality of analytes.

In some embodiments which can be used in conjunction with any of the above aspects and embodiments, a volume percent of the first aqueous buffer solution decreases during the course of elution and a volume percent of the second aqueous buffer solution increases during the course of elution.

In some embodiments which can be used in conjunction with any of the above aspects and embodiments, a volume percent of the first aqueous buffer solution decreases from 100% to 0% during the course of elution and a volume percent of the second aqueous buffer solution increases 0% to 100% during the course of elution.

In some embodiments which can be used in conjunction with any of the above aspects and embodiments, there is a linear increase in the volume percent of the second aqueous buffer solution during the course of elution.

In some embodiments which can be used in conjunction with any of the above aspects and embodiments, an automated system is used to mix the first and second aqueous buffer solutions to form the mobile phase.

In some embodiments which can be used in conjunction with any of the above aspects and embodiments, the method comprises varying amounts of the first aqueous buffer solution, the second aqueous buffer solution, and water. In some of these embodiments, an automated system may be used to mix the first aqueous buffer solution, the second aqueous buffer solution, and the water.

In some embodiments which can be used in conjunction with any of the above aspects and embodiments, the method further comprises detecting the plurality of analytes. In some of these embodiments, the plurality of analytes may be detected using a mass spectrometry technique such as electrospray ionization mass spectrometry.

In some embodiments which can be used in conjunction with any of the above aspects and embodiments, the plurality of analytes comprises a plurality of biomolecules,

In various embodiments, which may be used in conjunction with any of the above aspects and embodiments, the plurality of analytes may comprise a plurality of peptides or a plurality of proteins, including a plurality of mAb proteins, a plurality of non-mAb proteins, a plurality of fusion proteins, a plurality of antibody-drug conjugates (ADCs), and so forth. In certain embodiments, the plurality of analytes may comprise a plurality of proteins having pI values ranging from 6 to 10, among other possible values.

### DESCRIPTION OF THE DRAWINGS

FIGS. 1A-1D illustrate normalized MS response from SEC-MS observed as a function of mobile phase pH and ionic strength. Shown are normalized MS signal responses for IdeS digested (illustrated in FIG. 1A) and intact NIST mAb (illustrated in FIG. 1B) from size exclusion chromatography (SEC)-MS with 50 mM ammonium acetate mobile phase at different pH values. Also shown are normalized MS signal responses for IdeS digested (illustrated in FIG. 1C) and intact NIST mAb (illustrated in FIG. 1D) on SEC-MS with pH 5 ammonium acetate mobile phases of different ionic strength. For FIGS. 1A-1D, normalized MS signal response for IdeS digested NIST mAb was calculated as the percent ratio of summed peak areas of m/z 4245.8±1.5 and 3376.7±1.5 in extracted ion chromatograms to summed peak areas in IdeS NIST mAb elution window in UV chromatograms. Normalized MS signal response for intact NIST mAb was calculated as the percent ratio of peak areas of m/z 5295.1±1.5 in extracted ion chromatograms to summed peak areas in intact NIST mAb elution window in UV chromatograms. MS signal responses were measured on a 4.6×150 mm ACQUITY UPLC Protein BEH SEC Column, 200 Å, 1.7 μm with an ACQUITY UPLC® I-Class System coupled with a Xevo G2-S QTOF mass spectrometer. Separation conditions can be found in Example 1. FIGS. 1A-1D show that increases in mobile phase pH have more impact on mass spectrometry (MS) signal for intact and IdeS digested subunits of monoclonal antibodies (mAbs) than increases in ionic strength

FIGS. 2A-2C illustrate the effects of pH and ionic strength of mobile phases on online IEX-MS analysis of mAbs. Shown are UV chromatograms of NIST mAb (illustrated in FIG. 2A) along with pH (illustrated in FIG. 2B) and conductivity traces (illustrated in FIG. 2C) were obtained with mobile phases composed of 50 mM ammonium formate pH 3.9 as buffer A and 150 or 300 mM ammonium acetate pH 8.0 or 9.0 as buffer B. In FIGS. 2A-2C, chromatograms were acquired on a 2.1×50 mm BioResolve SCX mAb column with an ACQUITY UPLC® H-Class Bio System, and pH and conductivity traces were obtained with GE Healthcare Monitor pH/C-900. Separation conditions can be found in Example 2.

FIGS. 3A-3C illustrate ammonium formate/ammonium acetate versus ammonium acetate only mobile phases for online IEX-MS analysis of mAbs. UV chromatograms (illustrated in FIG. 3A) and normalized MS signal responses (illustrated in FIG. 3B) of intact NIST mAb, as well as pH and conductivity traces (illustrated in FIG. 3C) are shown, which were obtained with mobile phase system composed of either 40 mM ammonium formate 50 mM ammonium acetate pH 5.0, or 90 mM ammonium acetate pH 5.0 as buffer A, 200 mM ammonium acetate pH 8.2 as buffer B with a linear gradient of 0 to 100% B from 1.7 to 20.0 minutes. In FIGS. 3A-3C, chromatograms were acquired on a 2.1×50 mm BioResolve SCX mAb column with an ACQUITY UPLC® H-Class Bio System, pH and conductivity traces were obtained with GE Healthcare Monitor pH/C-900, and normalized MS signal responses were measured as the permille ratio of summed peak areas in base peak chromatograms and UV chromatograms on a 2.1×50 mm BioResolve SCX mAb column with an ACQUITY UPLC® I-Class System coupled with a Xevo G2-S QTOF mass spectrometer. Separation conditions can be found in Example 2 and 3.

FIGS. 4A-4C illustrate additional mobile phase ionic strength and gradient optimization to improve resolution of intact and IdeS digested mAbs for online IEX-MS analysis. Shown are UV chromatograms acquired with mobile phases composed of either 90 mM ammonium acetate pH 5.0 as buffer A and 200 mM ammonium acetate pH 8.4 as buffer B (FIG. 4A), 45 mM ammonium acetate pH 5.0 as buffer A and 150 mM ammonium acetate pH 8.4 as buffer B (FIG. 4B), or 20 mM ammonium acetate pH 5.0 as buffer A and 120 mM ammonium acetate pH 8.4 as buffer B (FIG. 4C). In FIGS. 4A-4C, chromatograms were acquired on a 2.1×50 mm BioResolve SCX mAb column with an ACQUITY UPLC® I-Class System. Separation conditions can be found in Example 3.

FIGS. 5A-5C illustrate mobile phase optimization to improve resolution of intact and IdeS digested mAbs for online IEX-MS analysis. The UV chromatograms of intact infliximab and IdeS digested trastuzumab were acquired with mobile phases composed of either 25 mM ammonium bicarbonate 30 mM acetic acid pH 5.3 as buffer A and 10 mM ammonium hydroxide in 2 mM acetic acid pH 10.18 as buffer B (illustrated in FIG. 5A), 50 mM ammonium formate pH 3.9 as buffer A and 500 mM ammonium acetate pH 7.4 as buffer B (illustrated in FIG. 5B), or 45 mM ammonium acetate pH 5.0 as buffer A and 150 mM ammonium acetate pH 8.4 as buffer B (illustrated in FIG. 5C). In FIGS. 5A-5C, chromatograms were acquired on a 2.1×50 mm BioResolve SCX mAb column with an ACQUITY UPLC® I-Class System. Separation conditions can be found in Example 3.

FIGS. 6A-6C illustrate best practices for mobile phase preparation for online IEX-MS analysis of mAbs. The mass spectra of IdeS digested infliximab and intact NIST mAb were acquired with mobile phases composed of 90 mM ammonium acetate pH 5.0 as buffer A and 200 mM ammonium acetate pH 8.4 as buffer B prepared with LC/MS grade water in glass bottles and glass labware (illustrated in FIG. 6A), or 0.2 μm filtered 18.2 MS2 water and plastic labware with pH measurement with a glass electrode filled with 3 M potassium chloride (illustrated in FIG. 6B) and without pH measurement with a glass electrode filled with 3 M potassium chloride (illustrated in FIG. 6C). In FIGS. 6A-6C, mass spectra were acquired on a 2.1×50 mm BioResolve SCX mAb column with an ACQUITY UPLC® I-Class System coupled with a Xevo G2-S QTOF mass spectrometer. Separation conditions can be found in Example 3.

### DETAILED DESCRIPTION

Mobile phases and their methods of use are described herein which afford robustness and high resolution IEX separations of proteins that can be directly coupled to electrospray ionization mass spectrometry. As seen from the detailed description of certain beneficial embodiments to follow, ammonium salt solutions have been developed.

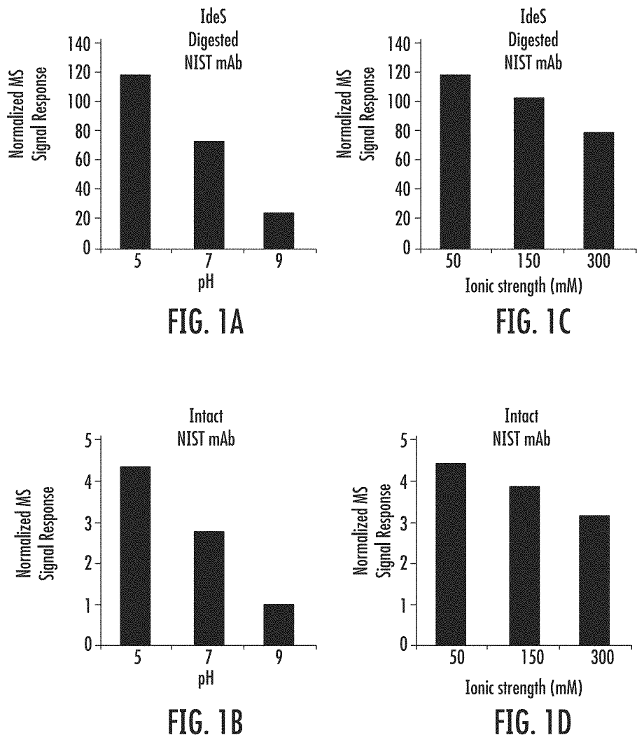

In particular, volatile mobile phase systems are described below that are based on ammonium salt solutions having certain beneficial pH values, concentrations and/or purity, taking into account protein electrospray ionization effects independent of ion exchange chromatography. The effects of mobile phase pH and ionic strength were also studied by size exclusion chromatography (SEC)-MS to obtain an orthogonal view on protein ionization efficiency and potential method considerations. The effect of mobile phase pH was studied by increasing the pH of 50 mM ammonium acetate mobile phase from 5 to 7 to 9. Intact and IdeS digested NIST mAb (reference material 8671) were studied. No change in charge state distributions was observed for IdeS digested or intact NIST mAb using buffers at different pH. MS signal responses of IdeS digested NIST mAb were normalized as the ratio of summed peak areas of m/z 4245.8±1.5 and 3376.7±1.5 in extracted ion chromatograms, which correspond to the most abundant charge states of F(ab′)2 and (Fc/2)₂ subunits, respectively, to summed peak areas in IdeS NIST mAb elution window in UV chromatograms. MS signal responses of intact NIST mAb were normalized as the ratio of peak areas of m/z 5295.1±1.5 in extracted ion chromatograms, which correspond to the most abundant charge states of intact NIST mAb, to summed peak areas in intact NIST mAb elution window in UV chromatograms. Major drops in MS signal responses were observed upon increasing buffer pH from 5 to 9 on both IdeS digested and intact NIST mAb (FIGS. 1A and 1B). Meanwhile, the effect of mobile phase ionic strength was studied by increasing the concentration of ammonium acetate mobile phase from 50 to 300 mM while keeping the pH at 5. No change of charge state distribution was observed on IdeS digested or intact NIST mAb using buffers at different concentrations. Only minor decreases in signal intensity were observed as ammonium acetate concentration increased from 50 to 300 mM (FIGS. 1C and 1D). These observations support the use of a dual pH/salt gradient method for this disclosure as applied to the IEX-MS analysis of IdeS digested and intact mAbs. That is, it is believed that a pH gradient only method would exhibit lower MS sensitivity and that a salt gradient only method would require the tuning of pH to be made applicable to different analytes.

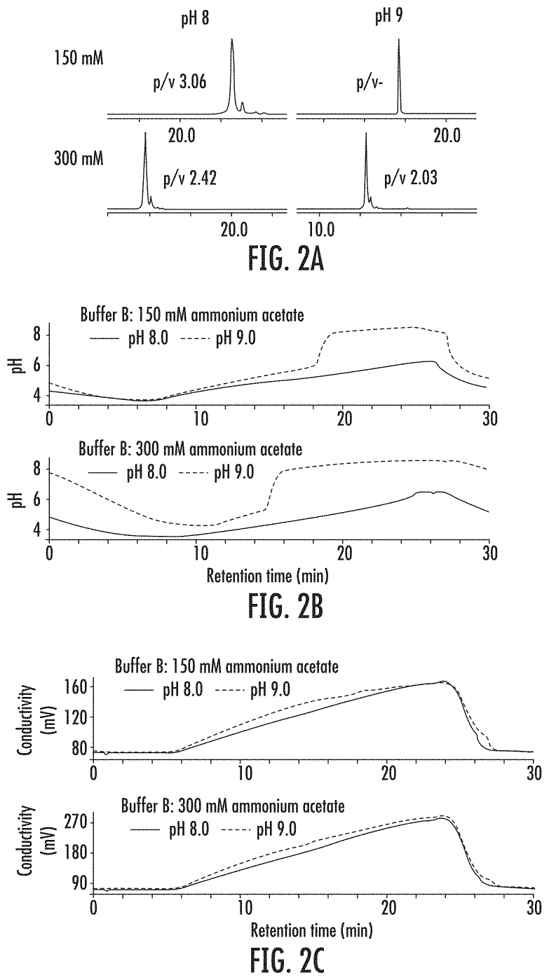

To evaluate the resolving power of volatile mobile phase systems with ion exchange chromatography, intact and IdeS digested NIST mAb (reference material 8671), infliximab, and trastuzumab were again analyzed. Peak-to-valley ratio (p/v) values of the first lysine variant of NIST mAb was calculated from UV chromatograms. Method optimization was performed to determine the pH and ionic strength of the eluent buffer solution in the mobile phase system. The retention and resolution of a high pI mAb, NIST mAb (pI of 9.2³), was monitored using a linear gradient between 50 mM ammonium formate pH 3.9 as the initial buffer solution (buffer A) and 150 or 300 mM ammonium acetate pH 8.0 or 9.0 as the eluent buffer solution (buffer B). As demonstrated in the UV chromatograms acquired on a 2.1×50 mm strong cation exchange stationary phase, the strongest retention and best resolution was observed using an eluent comprise of 150 mM ammonium acetate at a pH of 8 (FIG. 2A). Increasing the pH of 150 mM ammonium acetate from 8 to 9 resulted in co-elution of the main peak and the first lysine variant. A linear pH trace was observed using 150 mM ammonium acetate pH 8 as the eluent, while a sudden pH increase was observed at the retention window of NIST mAb after titrating the pH of the eluent to 9 (FIG. 2B), which was deemed to be the most probable cause of the poor resolution. Similarly, the resolution of NIST mAb was compromised after increasing the ionic strength of ammonium acetate from 150 to 300 mM. A sudden pH increase and shortened pH linear range was observed after titrating the pH of 300 mM ammonium acetate buffer to 9. Linear conductivity traces were observed using 150 or 300 mM ammonium acetate pH 8 solution as eluent (FIG. 2C), while a slight deviation from linearity were observed in the conductivity traces after titrating eluent pH to 9. Thus, a beneficial composition for the eluent in this mobile phase system is ammonium acetate solution having a pH between 7.5 and 9.0, more beneficially 8 and 8.5, and a concentration between 100 and 300 mM, more beneficially between 120 and 200 mM.

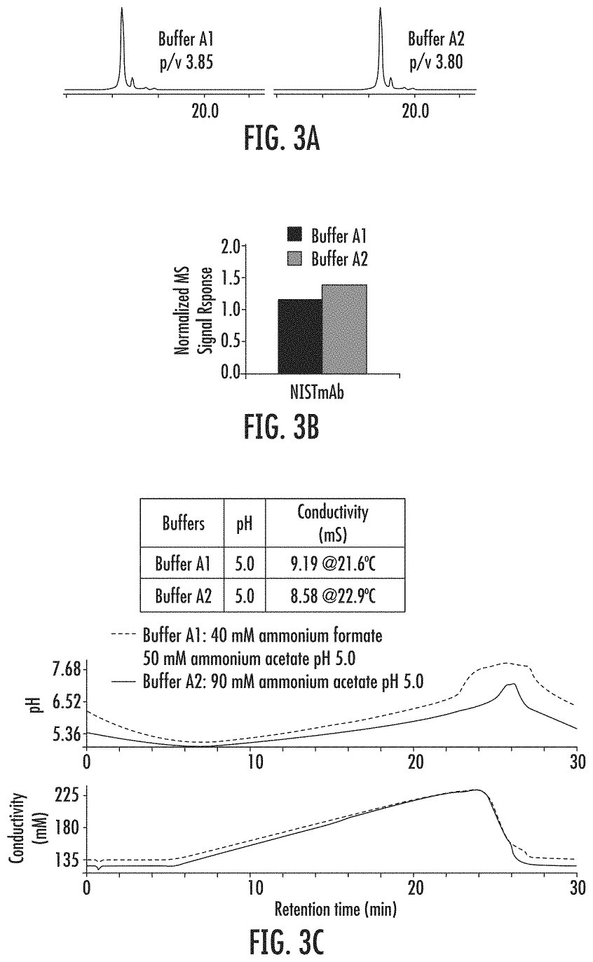

Further method optimization was performed to determine the most effective pH and ionic strength for the initial buffer solution applied in this mobile phase system. The retention and resolution of NIST mAb was monitored using a mobile phase system based on an initial buffer solution of either 40 mM ammonium formate 50 mM ammonium acetate pH 5.0 (buffer A1) or 90 mM ammonium acetate pH 5.0 (buffer A2) and 200 mM ammonium acetate pH 8.15 as the elution buffer solution (buffer B). With the same linear gradient of 0 to 100% B from 1.7 to 20 minutes, similar resolution was observed (FIG. 3A), while retention was stronger using buffer A2 than A1. Normalized MS signal responses were measured as the ratio of summed peak areas in base peak chromatograms acquired on a QTOF mass spectrometer and UV chromatograms measured at 280 nm on a 2.1×50 mm strong cation exchange column (FIG. 3B). Slightly higher MS signal response was observed using buffer A2. Linear pH traces were observed using either buffer A1 or A2 as the initial buffer solution and 200 mM ammonium acetate pH 8.2 as the eluent buffer solution (FIG. 3C), though a wider range of linearity was observed with buffer A2. Buffer A1 showed slightly higher conductivity than A2 as measured with an offline conductivity meter (9.19 mS @21.6° C. for buffer A1 vs. 8.58 mS @22.9° C. for buffer A2), despite the fact that they showed similar online conductivity traces. Although comparable LC resolution and MS sensitivity was observed using the buffers composed of the mixture of ammonium formate and ammonium acetate and the buffer only composed of ammonium acetate, a buffer system composed of a single ammonium salt offers the advantage of simplicity and tighter control on reagent purity. Thus, a beneficial initial buffer solution for the mobile phase system of this disclosure is ammonium acetate with a pH between 4 and 6, more beneficially 4.5 and 5.5, and a concentration between 20 and 120 mM, more beneficially between 40 and 100 mM.

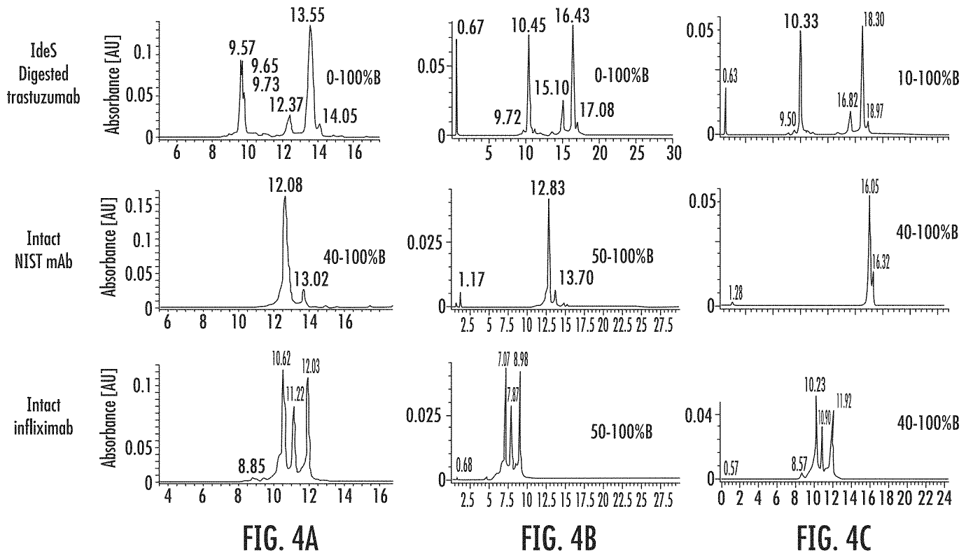

Additional optimization of mobile phase ionic strength and gradient garnered further improvements in resolution of intact and IdeS digested mAbs. While keeping the pH of the initial buffer solution at 5.0 and pH of the eluent buffer salutation at 8.4, it was found that a decrease in the ionic strength of ammonium acetate in the total mobile phase system could lead to improve chromatographic resolution. Decreasing the concentrations of the initial buffer solution and the eluent buffer solution from 90 and 200 mM to 45 mM and 150 mM, respectively, proved to be particularly effective. For example, the acidic variant of the main peak for intact NIST mAb was improved by these changes (FIGS. 4A and 4B). A similar observation was made on the first main peak of intact infliximab. However, further decreasing buffer ionic strength to 20 mM and 120 mM (initial solution versus eluent) did not show much benefit with respect to resolution on the separation of IdeS digested trastuzumab, intact NIST mAb, or intact infliximab (FIG. 4C). In summary, well defined boundaries have been established for constructing a mobile phase system for achieving robust IEX-MS methods. Ultimately, this effort has resulted in a simple, volatile buffer system that yields linear pH and conductivity traces and affords elution of mAbs and mAb subunits having diverse pI values and retention behavior.

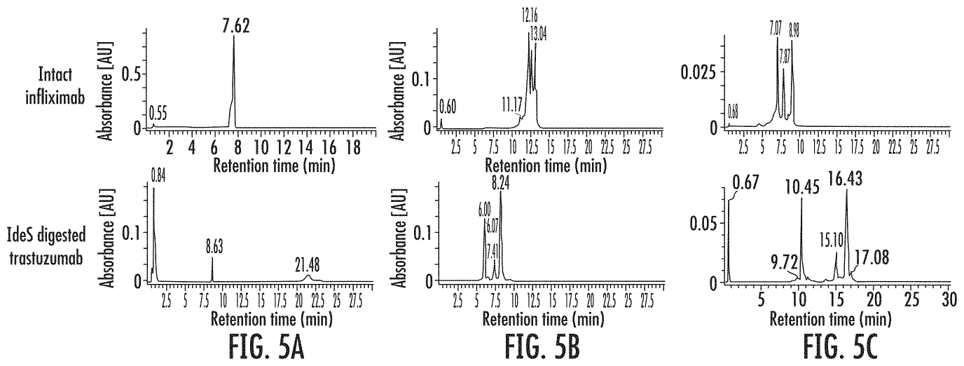

The chromatographic capabilities of the buffer system and method described herein are exemplary and this is easily demonstrated via comparison to alternatives. To this end, a study was performed to compare the buffer system of this disclosure to the pH gradient buffer based on ammonium bicarbonate, acetic acid, and ammonium hydroxide prepared by Fuss' et al., supra, and the dual salt/pH gradient method of Leblanc et al., supra. Direct comparisons of intact and IdeS digested mAb charge variant separations using the three methods were performed using a 3 μm non-porous sulfonated cation exchange stationary phase. Implementation of the buffer system described by Fuss' et al. failed to resolve intact infliximab (its three main peaks co-eluted) (FIG. 5A). Using a generic gradient from 40 to 100% eluent solution, this method also failed to provide an accurate profile of IdeS digested trastuzumab. MS signals corresponding to (Fc/2)₂ were observed from peaks at unretained retention times of 0.8-1.0 minutes, and only weak signal was observed for the F(ab′)₂ subunit at an approximate retention time of 13 minutes. A disadvantage of this method comes from it requiring very careful method optimization for different analytes, and it is not designed for analysis of IdeS digested subunits of mAbs. In contrast, the Leblanc method was designed to be used as a platform method for the analysis of IdeS digested subunits of mAbs (FIG. 5B). Through a comparison to LeBlanc's method, it was made clear that the best resolution for intact infliximab and IdeS digested trastuzumab was achieved with the inventive composition (FIG. 5C). Noteworthy increases in resolution were seen for the separation of intact infliximab and the subunits of trastuzumab.

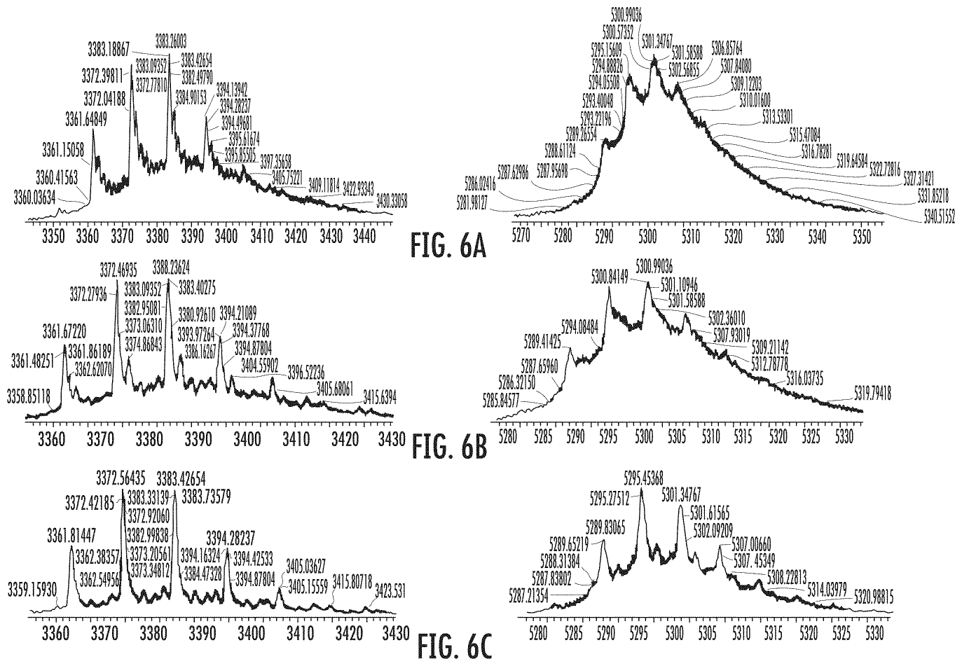

Lastly, the procedures for mobile phase preparation were optimized to improve mass spectral quality. The levels of sodium and potassium adducts in the mass spectra of IdeS digested infliximab and intact NIST mAb were monitored on a strong cation exchange column coupled with a QTOF mass spectrometer using mobile phases composed of 90 mM ammonium acetate pH 5.0 as initial buffer solution (buffer A) and 200 mM ammonium acetate pH 8.4 as eluent buffer solution (buffer B). Significant amounts of sodium adducts were observed using mobile phases prepared with LC/MS grade water in glass bottles and glass labware (FIG. 6A). In another case, a high level of potassium adducts was observed in the mass spectra acquired using mobile phases prepared with 0.2 μm filtered 18.2 MS2 water, plastic labware, and a pH measurement performed using a glass electrode filled with 3 M potassium chloride (FIG. 6B). Minimal levels of sodium or potassium adducts were achieved with mobile phases prepared with 0.2 μm filtered 18.2 MS2 water, plastic labware, and no pH measurement (FIG. 6C). It is beneficial for a glass free process to be applied to the preparation, storage and application of mobile phase concentrates and/or ready-to-use mobile phases so that sodium and potassium adducts are minimized and so that readily interpretable mass spectra can be obtained.

Thus, buffer systems are described herein that have been found to provide an attractive means to performing IEX-MS analyses of proteins, including intact and IdeS digested mAbs. One mobile phase solution of this method may be composed of ammonium acetate with a pH between 4 and 6, more beneficially 4.5 and 5.5 and a concentration between 20 and 120 mM, more beneficially between 40 and 100 mM. The other mobile phase solution may be composed of ammonium acetate with a pH between 7.5 and 9.0, more beneficially between 8 and 8.5, and a concentration between 100 and 300 mM, more beneficially between 120 and 200 mM. In alternative embodiments, the mobile phase solutions may be formed from ammonium formate, tetramethylammonium formate, tetramethylammonium acetate, triethylammonium acetate, or triethylammonium formate, among others. In order to achieve high quality mass spectra of proteins with minimal salt adducts, it is also beneficial for the ammonium acetate salt to have sodium and potassium content of less than 100 ppb, more beneficially, less than 20 ppb. As well, in a preferred embodiment, the mobile phase solutions may be prepared in a glass-free process and provided in glass-free containers in the form of buffer concentrates and/or ready to use mobile phases.

In some embodiments, these mobile phase solutions may contain organic co-solvent, including but not limited to acetonitrile, methanol, ethanol or isopropanol, at a concentration ranging from 1 to 50%, more beneficially 2 to 30% w/v, in order to mitigate bacterial growth.

In some embodiments, the mobile phase solutions may be employed in a binary gradient and yet in others in the form of ternary gradients with water. A ternary gradient with water can allow a separation to be finely tuned for pH change versus conductivity change, which can be an effective optimization parameter for developing a separation for a particular protein analyte.

In one embodiment, this disclosure is manifest as a method entailing the use of the described MS-compatible mobile phase buffer system for the charge variant profiling of protein therapeutics, including but not limited to mAb-based therapeutics.

Moreover, it has been found that it is beneficial for a glass free process to be applied to the preparation of mobile phase concentrates and/or ready to use mobile phases.

It is particularly advantageous to employ this mobile phase buffer system with cation exchange columns based on either carboxylated or sulfonated polymer resins. Accordingly, this mobile phase buffer system has made for a beneficial in pairing to the cation exchange stationary phases prepared as described in U.S. patent application Ser. No. 16/287,364, entitled “Polymer Particles with a Gradient Composition and Methods of Production thereof,” which is incorporated herein by reference. Additionally, this mobile phase buffer system may be advantageously paired with various commercially available cation exchange columns, including but not limited to Waters BioResolve™ SCX mAb, Thermo Scientific MAb Pac SCX, Thermo Scientific Pro Pac SCX, Thermo Scientific Pro Pac WCX, Thermo Scientific Pro Pac Elite WCX, Phenomenex BioZen WCX, Agilent Bio SCX, Agilent Bio WCX, Sepax Proteomix SCX, Sepax Proteomix WCX, Sepax Antibodix WCX, Tosoh TSKgel SP-STAT, Tosoh TSKgel SP-NPR, and YMC BioPro SP-F.

In various embodiments, this disclosure provides concentrates of the above-described buffered mobile phases, prepared in a 2 to 100 times concentrated volume, more beneficially a 5 to 20 times concentrated volume. Alternatively, the mobile phase system may be provided in a ready-to-use format.

In still others embodiments, this disclosure provides kits in which a user follows provided instructions to prepare a mobile phase from the above-mentioned buffer concentrates.

In further embodiment, kits may be provided that comprises a set of buffers, either in ready-to-use or concentrate form and a cation exchange column. In some embodiments, the above-mentioned ready-to-use buffers and buffer concentrates may be prepared with buffer salts containing less than 100 ppb concentrations of metals, including but not limited to sodium, potassium, and iron.

In addition, to lengthen their shelf life, these ready-to-use buffers and buffer concentrates may be formulated with a trace amount of bactericidal agent, including by not limited to 200 ppm of chloroform, and packaged with an oxygen absorbing packet.

Although optimized to achieve high resolution for mAb's, the methods, compositions and kits described herein can be used to separate other analytes, including other types of biomolecules, particular examples of which include peptides, other proteins including naturally occurring non-mAb proteins, fusion proteins and antibody drug conjugates (ADCs), among others.

Further details are presented in the Examples to follow.

### Example 1. SEC-UV-MS

FIG. 1 presents bar graphs obtained with conditions listed below:

### LC Conditions:

| | |
|---|---|
| System | ACQUITY UPLC I-Class |
| Data Acquisition | UNIFI |
| and Analysis | |
| Column Stationary | ACQUITY UPLC Protein BEH SEC |
| Phase | Column, 200 Å, 1.7 μm |
| Column Dimension | 4.6 × 150 mm |
| Column Temperature | 30° C. |
| Mobile phase A | 50 mM ammonium acetate pH titrated |
| | to 5.0, 7.0, or 9.0 (FIGS. 1A and IB); |
| | 50, 150, or 300 mM ammonium acetate |
| | pH titrated to 5.0 (FIGS. 1C and ID) |
| Seal Wash | 10% HPLC grade Methanol/ |
| | 90% HPLC grade water (v/v) |
| Seal Wash interval | 5 min |
| Sample Manager Wash | HPLC grade water |
| Sample Temp. | 10° C. |
| Sample: | IdeS digested NIST mAb (2 mg/mL) |
| | NIST mAb (10 mg/mL) |
| Injection Volume | 5 μL |
| UV Wavelength | 280 nm |

### MS Conditions:

| System | Xevo G2-S QTof mass spectrometer | |
|---|---|---|
| Mode | ESI+ sensitivity | |
| Capillary voltage | 3.0 | kV |
| Sampling Cone voltage | 150 | V |
| Source temp. | 135° | C. |
| Desolvation temp. | 500° | C. |
| Cone gas flow | 300 | L/h |
| Desolvation gas flow | 800 | L/h |

### Gradient Table:

| Time(min) | Flow Rate(mL/min) | % A | % B | Curve |
|---|---|---|---|---|
| Initial | 0.10 | 100 | 0 | Initial |
| 30.00 | 0.10 | 100 | 0 | 6 |

### Example 2. IEX-UV

FIGS. 2, 3A and 3C present chromatograms obtained with conditions listed below:

### LC Conditions:

Data Acquisition and Analysis Empower 3

| System | ACQUITY UPLC H-Class | |
|---|---|---|
| Data Acquisition | Empower 3 | |
| and Analysis | | |
| Column Stationary | BioResolve SCX mAb Column, 3 μm | |
| Phase | | |
| Column Dimension | 2.1 × 50 | mm |
| Column Temperature | 30° | C. |
| Seal Wash | 10% HPLC grade Methanol/ | |
| | 90% HPLC grade water (v/v) | |
| Seal Wash interval | 0.5 | min |
| Sample Manager Wash | HPLC grade water | |
| Sample Temp. | 10° C. | |
| Sample: | NIST mAb (10 mg/mL) | |
| Injection Volume | 1 | μL |
| UV Wavelength | 280 | nm |
| TUV Sampling Rate | 10 | points/sec |

| | |
|---|---|
| Filter Time Constant | Normal |
| Data Mode | Absorbance |
| Autozero On Inject | Yes |
| Start | |
| Autozero On Wavelength | Maintain Baseline |
| Online pH and cond. | GE Healthcare Monitor pH/C-900 |
| Detector | |

### Mobile Phases for FIG. 2:

| | |
|---|---|
| Mobile phase A | 50 mM ammonium formate pH 3.9 |
| Mobile phase B | 150 or 300 mM ammonium acetate |
| | titrated to pH 8.0 or 9.0 |

### Mobile Phases for FIG. 3:

| | |
|---|---|
| Mobile phase A | 40 mM ammonium formate 50 mM |
| | ammonium acetate pH 5.0, or |
| | 90 mM ammonium acetate pH 5.0 |
| Mobile phase B | 200 mM ammonium acetate pH 8.2 |

### Gradient Table for FIG. 2 and FIG. 3:

| Time(min) | Flow Rate(mL/min) | % A | % B | Curve |
|---|---|---|---|---|
| Initial | 0.11 | 100 | 0 | Initial |
| 1.70 | 0.11 | 100 | 0 | 6 |
| 20.00 | 0.11 | 0 | 100 | 6 |
| 20.90 | 0.11 | 0 | 100 | 6 |
| 21.90 | 0.11 | 100 | 0 | 6 |
| 30.00 | 0.11 | 100 | 0 | 6 |

### Example 3. IEX-UV-MS

FIG. 3B, FIG. 4, FIG. 5, and FIG. 6 present chromatograms obtained with conditions listed below:

### LC Conditions:

| System | ACQUITY UPLC I-Class | |
|---|---|---|
| Data Acquisition and Analysis | UNIFI | |
| Column Stationary Phase | BioResolve SCX mAb Column, 3 μm | |
| Column Dimension | 2.1 × 50 | mm |
| Column Temperature | 30° | C. |
| Seal Wash | 10% HPLC grade Methanol/90% HPLC | |
| | grade water (v/v) | |
| Seal Wash interval | 5 | min |
| Sample Manager Wash | HPLC grade water | |
| Sample Temp. | 10° C. | |
| Sample: | IdeS digested trastuzumab (2 mg/mL) | |
| | IdeS digested infliximab (2 mg/mL) | |
| | NIST mAb (10 mg/mL) | |
| | Infliximab (10 mg/mL) | |
| UV Wavelength | 280 | nm |

### MS Conditions:

| System | Xevo G2-S QTof mass spectrometer | |
|---|---|---|
| Mode | ESI+ sensitivity | |
| Capillary voltage | 3.0 | kV |
| Sampling Cone voltage | 150 | V |
| Source temp. | 135° | C. |
| Desolvation temp. | 500° | C. |
| Cone gas flow | 300 | L/h |
| Desolvation gas flow | 800 | L/h |

### Mobile Phases for FIG. 3B:

| | |
|---|---|
| Mobile phase A | 40 mM ammonium formate 50 mM |
| | ammonium acetate pH 5.0, or 90 |
| | mM ammonium acetate pH 5.0 |
| Mobile phase B | 200 mM ammonium acetate pH 8.2 |

### Gradient Table for FIG. 3B:

| Time(min) | Flow Rate(mL/min) | % A | % B | Curve |
|---|---|---|---|---|
| Initial | 0.11 | 100 | 0 | Initial |
| 1.70 | 0.11 | 100 | 0 | 6 |
| 20.00 | 0.11 | 0 | 100 | 6 |
| 20.90 | 0.11 | 0 | 100 | 6 |
| 21.90 | 0.11 | 100 | 0 | 6 |
| 30.00 | 0.11 | 100 | 0 | 6 |

### Mobile Phases for FIG. 4A and FIG. 6:

| | |
|---|---|
| Mobile phase A | 90 mM ammonium acetate pH 5.0 |
| Mobile phase B | 200 mM ammonium acetate pH 8.4 |

### Gradient Table for FIG. 4, FIG. 5C, and FIG. 6:

| Time(min) | Flow Rate(mL/min) | % A | % B | Curve |
|---|---|---|---|---|
| Initial | 0.10 | 100 | 0 | Initial |
| 1.00 | 0.10 | 100 | 0 | 6 |
| 21.00 | 0.10 | 0 | 100 | 6 |
| 22.00 | 0.10 | 0 | 100 | 6 |
| 23.00 | 0.10 | 100 | 0 | 6 |
| 30.00 | 0.10 | 100 | 0 | 6 |

### Mobile Phases for FIG. 5A:

| | |
|---|---|
| Mobile phase A | 25 mM ammonium bicarbonate |
| | and 30 mM acetic acid pH 5.3 |
| Mobile phase B | 10 mM ammonium hydroxide in |
| | 2 mM acetic acid pH 10.18 |

### Gradient Table for FIG. 5A Intact Infliximab:

| Time(min) | Flow Rate(mL/min) | % A | % B | Curve |
|---|---|---|---|---|
| Initial | 0.11 | 60 | 40 | Initial |
| 0.50 | 0.11 | 55 | 45 | 6 |
| 10.00 | 0.11 | 45 | 55 | 6 |
| 11.00 | 0.11 | 0 | 100 | 6 |
| 12.00 | 0.11 | 60 | 40 | 6 |
| 20.00 | 0.11 | 60 | 40 | 6 |

### Gradient Table for FIG. 5A IdeS Digested Trastuzumab:

| Time(min) | Flow Rate(mL/min) | % A | % B | Curve |
|---|---|---|---|---|
| Initial | 0.11 | 60 | 40 | Initial |
| 0.50 | 0.11 | 60 | 40 | 6 |
| 20.50 | 0.11 | 0 | 100 | 6 |
| 21.50 | 0.11 | 0 | 100 | 6 |
| 22.50 | 0.11 | 60 | 40 | 6 |
| 30.00 | 0.11 | 60 | 40 | 6 |

### Mobile Phases for FIG. 5B:

| | |
|---|---|
| Mobile phase A | 50 mM ammonium formate pH 3.9 |
| Mobile phase B | 500 mM ammonium acetate pH 7.4 |

### Gradient Table for FIG. 5B:

| Time(min) | Flow Rate(mL/min) | % A | % B | Curve |
|---|---|---|---|---|
| Initial | 0.11 | 85 | 15 | Initial |
| 1.70 | 0.11 | 85 | 15 | 6 |
| 20.00 | 0.11 | 50 | 50 | 6 |
| 20.90 | 0.11 | 30 | 70 | 6 |
| 21.90 | 0.11 | 85 | 15 | 6 |
| 30.00 | 0.11 | 85 | 15 | 6 |

1. A chromatographic elution kit comprising (a) a first aqueous buffer solution having a first pH and comprising a first organic acid salt in a first concentration and (b) a second aqueous buffer solution having a second pH and comprising the first organic acid salt in a second concentration, wherein the first organic acid salt comprises a first organic acid ammonium salt, wherein the second pH is greater than the first pH, and wherein the second concentration is greater than the first concentration.

2. The chromatographic elution kit of claim 1, wherein each of the first and second aqueous buffer solutions contains at most 20% of a second organic acid ammonium salt that differs from the first organic acid ammonium salt.

3. The chromatographic elution kit of claim 1, wherein the first organic acid salt consists essentially of the first organic acid ammonium salt.

4. The chromatographic elution kit of claim 1, where in the first organic acid ammonium salt is the sole organic acid ammonium salt in each of the first and second aqueous buffer solutions.

5. The chromatographic elution kit of claim 1, wherein the first and second aqueous buffer solutions each has a concentration of sodium and potassium that is less than 100 ppb.

6. The chromatographic elution kit of claim 1, wherein the first aqueous buffer solution has pH between 4 and 6 and a concentration of the first organic acid ammonium salt that is between 20 and 120 mM, wherein the second aqueous buffer solution has a pH between 7.5 and 9.0 and a concentration of the first organic acid ammonium salt that is between 100 and 300 mM.

7. The chromatographic elution kit of claim 1, wherein the first aqueous buffer solution has pH between 4 and 6 and a concentration of the first organic acid ammonium salt that is between 30 to 100 mM, and wherein the second aqueous buffer solution has a pH between 7.5 and 9.0 and a concentration of the first organic acid ammonium salt that is between 100 to 200 mM.

8. The chromatographic elution kit of claim 1, wherein the first aqueous buffer solution has a conductivity ranging from 0.1 millisiemins (mS) to 10 mS and wherein the second aqueous buffer solution has a conductivity ranging from 3 mS to 100 mS.

9. The chromatographic elution kit of claim 1, wherein a plot of pH versus volume percent of the first aqueous buffer solution relative to a total volume for a binary mixture of the first aqueous buffer solution and the second aqueous buffer solution is linear.

10. The chromatographic elution kit of claim 1, wherein a plot of conductivity versus volume percent of the first aqueous buffer solution relative to a total volume for a binary mixture of the first aqueous buffer solution and the second aqueous buffer solution is linear.

11. The chromatographic elution kit of claim 1, wherein a plot of conductivity versus volume percent of the first aqueous buffer solution relative to a total volume for a binary mixture of the first aqueous buffer solution and the second aqueous buffer solution does not exhibit a negative slope.

12. The chromatographic elution kit of claim 1, further comprising instructions for diluting each of the first and second aqueous buffer solutions that when followed result in a diluted first aqueous buffer solution having a pH between 4 and 6 and a concentration of the first organic acid ammonium salt that is between 20 and 120 mM and a diluted second aqueous buffer solution having a pH between 7.5 and 9.0 and a concentration of the first organic acid ammonium salt that is between 100 and 300 mM.

13. The chromatographic elution kit of claim 12, wherein, when followed, the instructions for diluting each of the first and second aqueous buffer solutions result in a diluted first aqueous buffer solution having a pH between 4.5 and 5.5 and a concentration of the first organic acid ammonium salt that is between 40 and 100 mM and a diluted second aqueous buffer solution having a pH between 8.0 and 8.5 and a concentration of the first organic acid ammonium salt that is between 120 and 200 mM.

14. The chromatographic elution kit of claim 12, wherein the diluted first aqueous buffer solution has a conductivity ranging from 0.1 mS to 10 mS and wherein the diluted second aqueous buffer solution has a conductivity ranging from 3 mS to 100 mS.

15. The chromatographic elution kit of claim 12, wherein a plot of pH versus volume percent of the diluted first aqueous buffer solution relative to a total volume for a binary mixture of the diluted first aqueous buffer solution and the diluted second aqueous buffer solution is linear.

16. The chromatographic elution kit of claim 12, wherein a plot of conductivity versus volume percent of the diluted first aqueous buffer solution relative to a total volume for a binary mixture of the diluted first aqueous buffer solution and the diluted second aqueous buffer solution is linear.

17. The chromatographic elution kit of claim 12, wherein a plot of conductivity versus volume percent of the diluted first aqueous buffer solution relative to a total volume for a binary mixture of the diluted first aqueous buffer solution and the diluted second aqueous buffer solution does not exhibit a negative slope.

18. The chromatographic elution kit of claim 1, wherein the first organic acid ammonium salt is formed from an organic acid anion selected from formate, acetate, difluoroacetate, trifluoroacetate, propionate, butyrate, carbonate, bicarbonate, oxalate, malonate, succinate, maleate, glutarate, glycolate, lactate, malate, citrate or gluconate and an ammonium cation selected from ammonium, monoalkyl ammonium, dialkyl ammonium, trialkyl ammonium, or tetraalkyl ammonium.

19. The chromatographic elution kit of claim 1, wherein the first organic acid ammonium salt is selected from ammonium formate, ammonium acetate, tetramethylammonium formate, tetramethylammonium acetate, triethylammonium acetate, or triethylammonium formate.

20. The chromatographic elution kit of claim 1, wherein each of the first and second aqueous buffer solutions are contained in polymeric vessels.

21. The chromatographic elution kit of claim 1, wherein each of the first and second aqueous buffer solutions further comprises a miscible organic co-solvent at a concentration ranging from 1 to 50%.

22. The chromatographic elution kit of claim 21, wherein the miscible organic co-solvent is selected from acetonitrile, methanol, ethanol, n-propanol, isopropanol.

23. The chromatographic elution kit of claim 1, further comprising an ion exchange chromatographic material.

24. The chromatographic elution kit of claim 23, comprising a separation device comprising a housing comprising an inlet and an outlet that is configured to accept and hold the ion-exchange chromatography material.

25. The chromatographic elution kit of claim 23, wherein the ion-exchange chromatography material is a cation exchange chromatography material.

26. The chromatographic elution kit of claim 25, wherein the cation exchange chromatography material comprises carboxylate groups, sulfonate groups, or both.

27-42. (canceled)
